(19) United States
(12) Patent Application Publication
(10) Pub. No.: US 2012/0091881 A1
(43) Pub. Date: Apr. 19, 2012

(54) ELECTRON EMITTING DEVICE

(75) Inventors: Eiji Ozaki, Tokyo (JP); Taiko Motoi, Yokohama-shi (JP); Ryoji Fujiwara, Chigasaki-shi (JP); Akiko Kitao, Kawasaki-shi (JP)

(73) Assignee: CANON KABUSHIKI KAISHA, Tokyo (JP)

(21) Appl. No.: 13/252,001

(22) Filed: Oct. 3, 2011

(30) Foreign Application Priority Data
Oct. 15, 2010 (JP) 2010-232626

(51) Int. Cl. H01J 19/24; H01J 1/304

(52) U.S. Cl. 313/495; 313/310

(57) ABSTRACT

The present invention provides an electron emitting device that includes a cathode, and a gate onto which electrons field-emitted from the cathode are irradiated. The gate includes at least a layer containing molybdenum and oxygen provided at a portion onto which the electrons field-emitted from the cathode are irradiated. The layer has peaks in a range of 397 eV through 401 eV, a range of 414 eV through 418 eV, a range of 534 eV through 538 eV, and a range of 540 eV through 547 eV, respectively, in a spectrum measured by electron energy loss spectroscopy using a transmission electron microscope.

### BACKGROUND OF THE INVENTION

1. Field of the Invention

The present invention relates to a field emission type electron emitting device for use in an image display apparatus or the like.

2. Description of the Related Art

A vertical type electron emitting device discusses in Japanese Patent Application Laid-Open No. 2010-146915, and a Spindt type electron emitting device are known as a field emission type electron emitting device for use in an image display apparatus or the like. It is known that the surface configuration of each of a cathode and a gate of the field emission type electron emitting device contribute largely to electron emitting characteristics thereof. Particularly, the surface configuration of the cathode relates directly to electron emitting. Accordingly, numerous improvements have been made thereto. On the other hand, improvements have been made to the gate to solve problems in a manufacturing process, rather than to improve the electron emitting characteristics to which the gate relates directly.

Japanese Patent Application Laid-Open No. 5-21002 discusses a method of forming oxidized film on each of an emitter tip (i.e., a cathode) made of metallic molybdenum and a gate layer made of metallic molybdenum and adjusting, in a process of removing the oxidized film, an edge shape of the emitter tip and a distance between the emitter tip and the gate layer. Japanese Patent Application Laid-Open No. 9-306339 discusses a method of forming MoO₃ film on a surface of a molybdenum cathode and cleaning the surface of the cathode by heating and removing the MoO₃ film when the cathode is mounted on the device.

Field emission type electron emitting devices which excel in electron emitting characteristics are demanded.

### SUMMARY OF THE INVENTION

According to an aspect of the present invention, an electron emitting device includes a cathode, and a gate onto which electrons field-emitted from the cathode are irradiated. The gate includes at least a layer containing molybdenum and oxygen provided at a portion onto which the electrons field-emitted from the cathode are irradiated. The layer has peaks in a range of 397 electron-volts (eV) to 401 eV, a range of 414 eV to 418 eV, a range of 534 eV to 538 eV, and a range of 540 eV to 547 eV, respectively, in a spectrum measured by electron energy loss spectroscopy using a transmission electron microscope.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are graphs each illustrating an electron energy loss (EEL) spectrum of a film containing molybdenum and oxygen.

FIGS. 2A, 2B, and 2C are schematic diagrams each illustrating an example of a configuration of an electron emitting device.

FIGS. 3A through 3F are graphs each illustrating an EEL spectrum of a standard specimen of a molybdenum compound.

FIGS. 4A and 4B are graphs each illustrating an EEL spectrum of a comparative example.

FIGS. 5A and 5B are graphs each illustrating an electron emitting characteristic.

FIGS. 6A through 6F are schematic diagrams illustrating a process of manufacturing an electron emitting device.

FIG. 7 is a schematic diagram illustrating an example of a configuration of a measurement system for measuring electron emitting characteristic.

FIGS. 8A through 8C are schematic diagrams illustrating steps of a process of manufacturing an electron emitting device.

### DETAILED DESCRIPTION OF THE EMBODIMENTS

Various exemplary embodiments, features, and aspects of the invention will be described in detail below with reference to the drawings.

An exemplary embodiment is described in detail below with reference to the drawings. The scope of the present invention is not limited only to dimensions, materials, shapes and relative arrangements of components described in the exemplary embodiment, unless otherwise specifically described.

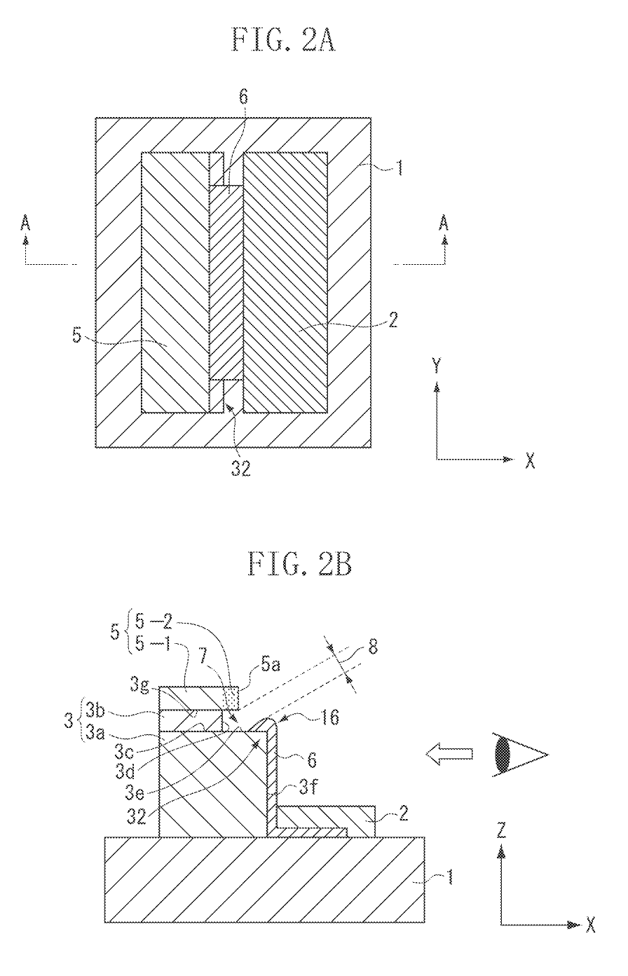

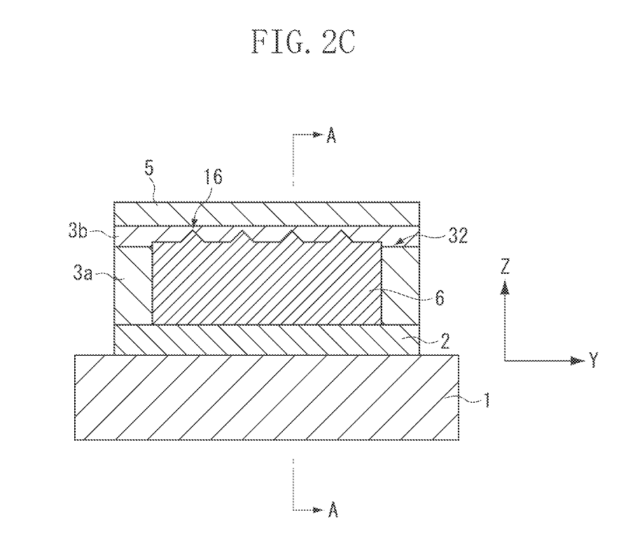

First, an example of a configuration of an electron emitting device according to the present exemplary invention is described with reference to FIGS. 2A through 2C. The electron emitting device according to the present invention includes at least a cathode, and a gate provided to face the cathode (edge of cathode) across an air gap. Electrons field-emitted from the cathode are irradiated onto the gate. At least a part of the electrons irradiated onto the gate are scattered by the gate 5. Then, at least apart of the scattered electrons reach an anode placed away from the electron emitting device, as illustrated in FIG. 7. Generally, in such an electron emitting device in which electrons field-emitted from the cathode are irradiated onto the gate, a distance between the cathode and the gate (i.e., a width of the air gap provided therebetween) depending upon a voltage applied therebetween is less than 50 nanometers (nm).

FIG. 2A is a schematic plan view illustrating an example of a configuration of the electron emitting device to which the present invention is preferably applied. FIG. 2B is a schematic cross-sectional view taken on line A-A illustrated in FIG. 2A and line A-A illustrated in FIG. 2C. FIG. 2C is a schematic side view illustrating the electron emitting device, which is taken from a direction of an arrow illustrated in FIG. 2B. The illustrated electron emitting device includes an insulating member 3 stacked on a surface of a substrate 1, and a gate 5 provided on the top surface of the insulating member 3 so that the insulating member 3 is sandwiched between the substrate 1 and the gate 5. In addition, the electron emitting device includes a cathode 6 provided on a side surface of insulating member 3 (i.e., a surface 3f illustrated in FIG. 2B). The cathode 6 partly extends up to a part of the top surface of the insulating member 3 and has a protruding portion 16. The protruding portion 16 serving as a distal-end of the cathode 6 corresponds to an electron emitting portion.

The protruding portion 16 is provided on a corner portion 32 serving as a boundary portion between the side surface (i.e., the surface 3f illustrated in FIG. 2B) and the top surface (i.e., a surface 3e illustrated in FIG. 2B). FIG. 2B illustrates the side surface of insulating member 3 (i.e., the side surface 3f of a first insulating layer 3a) as being perpendicular to a surface of the substrate 1. However, the side surface of the insulating member 3 can be set as a slope inclined to the surface of the substrate 1 at a tilt angle that is less than 90° (e.g., within a range of 45° through 80°).

In the example described here, the cathode 6 has a plurality of protruding portions 16, as illustrated in FIG. 2C. The plurality of protruding portions 16 are arranged along the corner portion 32 serving as the boundary portion between the side surface of insulating member 3 (i.e., the surface 3f illustrated in FIG. 2B) of the insulating member 3 and the top surface (i.e., the surface 3e illustrated in FIG. 2B) thereof. As compared with a configuration provided no protruding portions 16 on the cathode 6, a position of the electron emitting portion can firmly be determined by providing the plurality of protruding portions 16 thereon. In addition, as compared with the configuration provided no protruding portions 16 thereon, the electron emitting portion can emit electrons at a lower voltage.

A gap 8 which is an air gap is provided between the gate 5 and the protruding portion 16. A voltage is applied between the cathode 6 and the gate 5 so that a potential-level of the gate 5 is higher than a potential-level of the cathode 6. Thus, electrons are field-emitted from each protruding portion 16 of the cathode 6.

A position at which the gate 5 is located is not limited to that illustrated in FIGS. 2A through 2C. In other words, the gate 5 has only to be located at a predetermined distance from the cathode 6 such that an electric field, whose strength is sufficient to cause the protruding portions 16 serving as electron emitting portions to emit electrons, can be applied to the protruding portions 16. For example, being similar to a conventional known surface-conduction electron-emitter device, an electron emitting device according to the present invention can be configured such that a film-like cathode and a film-like gate are provided on a surface of the same substrate to face each other across a gap formed therebetween. Alternatively, being similar to a conventional known Spindt type electron emitting device, an electron emitting device according to the present invention can be configured with a columnar or spindle-like cathode and a gate provided at a predetermined distance from an end of the cathode to surround the cathode.

In the example described here, the insulating member 3 is configured by a laminated body of a first insulating layer 3a and a second insulating layer 3b. However, the insulating member 3 can be configured with a single insulating layer. Furthermore the insulating member 3 can be configured with three or more insulating layers.

In the configuration illustrated in FIGS. 2A through 2C, the second insulating layer 3b is stacked on the top surface 3e of the first insulating layer 3a. In other words, a side surface 3d of the second insulating layer 3b is provided to be apart from the cathode 6 more than the side surface 3f of the first insulating layer 3a. Thus, the top surface of the insulating member 3 can be provided with a concave portion 7. Accordingly, the top surface of the insulating member 3 has a step. Therefore, the step portion is configured with a first top surface of the insulating member 3, which is more apart from the substrate 1, a second top surface thereof, which is closer to the substrate 1, and a side surface which connects the first top surface and the second top surface to each other. In addition the second top surface is configured to be connected to the side surface 3f via the corner portion 32.

When the insulating member 3 is configured with the first insulating layer 3a and the second insulating layer 3b, the first top surface corresponds to a top surface 3g of the second insulating layer 3b. The second top surface corresponds to a part of the top surface 3e of the first insulating layer 3a, which is exposed to the concave portion 7. The side surface connecting the first top surface and the second top surface to each other corresponds to the side surface 3d of the second insulating layer 3b. Thus, in the configuration illustrated in FIG. 2B, the concave portion 7 is configured with the second top surface, the side surface connecting the first top surface and the second top surface, and a bottom surface of the gate 5.

In the configuration illustrated in FIGS. 2A through 2C, the gate 5 has a base portion 5-1 supported by the insulating member 3, and a protruding portion 5-2 protruded towards the cathode 6 from the base portion 5-1. The base portion 5-1 of the gate 5 is provided on the top surface (i.e., the first top surface 3g) of the insulating member 3. The protruding portion 5-2 of the gate 5 is provided to extend like the eaves opposite the second top surface across an air gap (i.e., to be separated from the second top surface).

The gate 5 is separated from the cathode 6, connected to a part of the top surface of the insulating member 3, which is not covered with the cathode 6, and supported by the insulating member 3. The gate 5 includes the base portion 5-1, and the protruding portion 5-2 which protrudes from the base portion 5-1 to be close to the cathode 6 (particularly, to each protruding portion 16 of the cathode 6). Generally, if the surface of the substrate 1 is flat, the protruding portion 5-2 of the gate 5 protrudes in (substantially) parallel to the surface of the substrate 1.

A protruding direction in which the protruding portion 5-2 of the gate 5 protrudes intersects with a protruding direction in which each protruding portion 16 of the cathode 16 protrudes. In other words, as illustrated in FIG. 2B, the protruding direction in which the protruding portion 5-2 of the gate 5 protrudes is perpendicular to (i.e., intersects at right angles with) the protruding direction in which each protruding portion 16 of the cathode 16 protrudes. It is useful that the protruding direction in which the protruding portion 5-2 of the gate 5 protrudes intersects with the protruding direction in which each protruding portion 16 of the cathode 16 protrudes, at an angle equal to or less than 90°. The protruding direction in which each protruding portion 16 protrudes can roughly be paraphrased as a direction along the side surface of the insulating member 3, in a cross-section illustrated in FIG. 2B. The protruding direction in which the protruding portion 5-2 protrudes can roughly be paraphrased as a direction in which the protruding portion 5-2 extends from the base portion 5-1, in the cross-section illustrated in FIG. 2B.

The base portion 5-1 and the protruding portion 5-2 are concepts used to facilitate understanding. The present invention can employ a configuration in which the base portion 5-1 and the protruding portion 5-1 are formed integrally with each other, in other words, a configuration in which there is no clear boundary therebetween.

The base portion 5-1 is connected to a part of the top surface of the insulating member 3 (i.e., placed on the top surface of the insulating member 3). When the insulating member 3 is configured with the first insulating layer 3a and the second insulating layer 3b, as illustrated in FIG. 2B, the base portion 5-1 is connected to the top surface 3g of the second insulating layer. The base portion 5-1 can be configured such that a part of the bottom surface of the base portion 5-1 is not connected to the top surface of the insulating member 3. In other words, the base portion 5-1 can be configured such that an air gap is formed between the top surface of the insulating member 3 and a part (i.e., an end portion at the side of the cathode 6) of the base portion 5-1. However, the configuration illustrated in FIG. 2B is such that the entire bottom surface of the base portion 5-1 is connected to a part of the top surface of the insulating member 3.

FIG. 2B illustrates a case where an angle of a side surface 5a of the gate 5 with respect to the bottom surface (i.e., a surface facing the top surface of the insulating member 3) thereof is 90°. However, to enhance electron emitting efficiency η, such an angle may be set to be smaller than 90°.

According to the example described here, when the electron emitting device is viewed from above (as illustrated in FIG. 2A), an outer circumference (corresponding to the side surface 5a) of the protruding portion 5-2 of the gate 5 has a rectilinear shape. However, the shape of the outer circumference of the protruding portion of the gate of the electron emitting device according to the present exemplary embodiment is not limited thereto. The outer circumference (corresponding to the side surface 5a) of the protruding portion of the gate can be configured by, e.g., consecutive circular arcs like a sine curve, alternatively, e.g., consecutively and saliently connected linear-segments like triangular waves. Alternatively, the shape of the outer circumference corresponding to the side surface 5a can be basically set as a combination of a circular arc shape (having a curvature) set as the shape of each protruding portion 5-2, and a linear shape set as the shape of each part between the adjacent protruding portions 5-2.

From a viewpoint of position alignment with the protruding portion 16 of the cathode 6, it is desirable that at least the side surface 5a of the protruding portion 5-2 (particularly a part at a distal-end of the protruding portion 5-2, which is most distant from the base portion 5-1) is shaped like a circular arc (having a curvature).

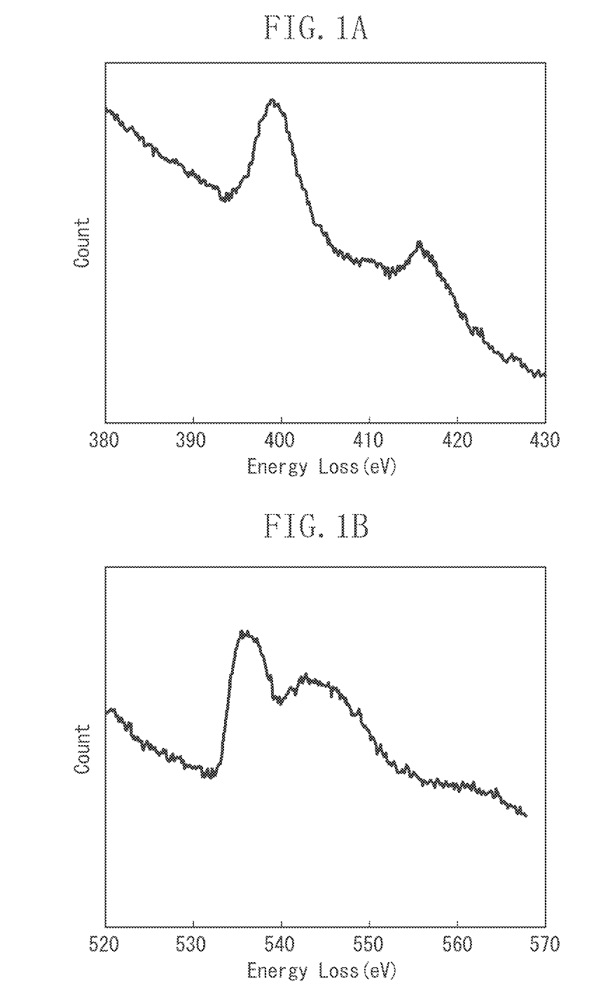

The gate 5 includes a layer containing molybdenum and oxygen. The layer containing molybdenum and oxygen has peaks in a range of 397 eV to 401 eV, a range of 414 eV to 418 eV, a range of 534 eV to 538 eV, and a range of 540 eV to 547 eV, respectively, in a spectrum measured according to a transmission electron microscope (TEM) electron energy loss spectroscopy (EELS) method (TEM-EELS method) (see FIGS. 1A and 1B). The electron emitting device provided with a gate having such a spectrum can have favorable electron emitting characteristics. Electron emitting device without having such peaks are low in electron emitting efficiency.

As described above, the “TEM-EELS method” designates a method of performing microscope electron energy loss spectroscopy using a transmission electron microscope. The TEM-EELS method is discussed in Shunsuke Muto et al. (2002), “Structural Analysis for Local Region of Light Element Material Utilizing Inner Shell Excitation Spectrum in Transmission Electron Energy Loss Spectroscopy”, Surface Science, Vol. 23, No. 6, pp. 381-388.

The gate 5 can be configured only by the above layer. Alternatively, the gate 5 can be configured by providing a gate electrode and stacking the above layer (gate layer) on at least a part of the gate electrode, more specifically, on a portion onto which electrons emitted from a cathode are irradiated. In the configuration illustrated in FIG. 2B, most of electrons irradiated onto the gate 5 within electrons, which is field emitted from cathode 6, incident upon the side surface 5a of the gate 5.

Thus the above layer may be useful to be provided on at least a side surface of the gate electrode. Moreover the gate layer may be more useful also to be provided on the bottom surface (more specifically, a part thereof facing the second top surface of the above insulating member 3 across an air gap (i.e., to be separated therefrom)) of the gate electrode. Accordingly, e.g., the protruding portion 5-2 illustrated in FIG. 2B can be configured by the above layer.

When the electron emitting device according to the present invention is drove, an anode 20 is provided at a predetermined distance (e.g., several millimeters (mm)) from the electron emitting device, as illustrated in FIG. 7. Then, an electric potential sufficiently higher than that applied to the gate 5 (e.g., the former level is by two orders of magnitude higher than the latter level) is applied to the anode 20. Consequently, electrons field-emitted from the cathode 6 are scattered on the surface of the gate 5. Then, the electrons reach the anode 20. When a luminescent material, such as a phosphor, which emits light by being irradiated with electrons, is provided on the anode 20, a light emitting device can be formed. A display device can be formed by arranging a large number of such light emitting devices. In addition, when the electric potential to be applied to an anode 20 is set at several hundred kilo-volts (kV), a radiation generator can be formed.

Hereinafter, a specific exemplary example of the electron emitting device according to the present invention is described.

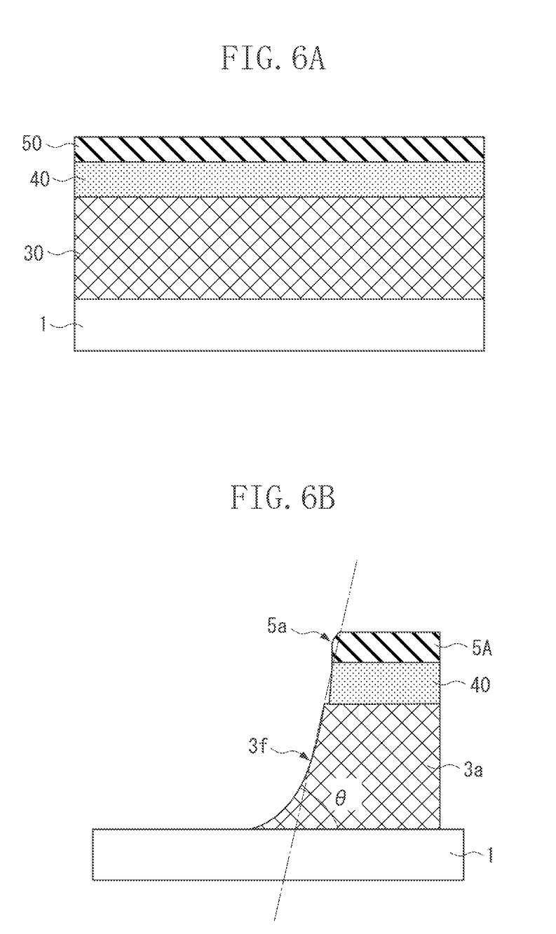

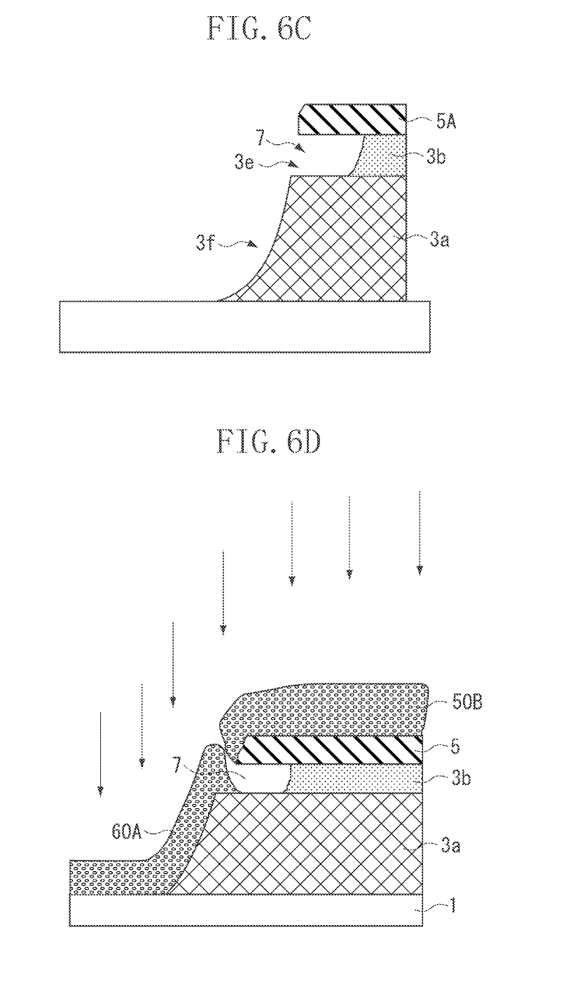

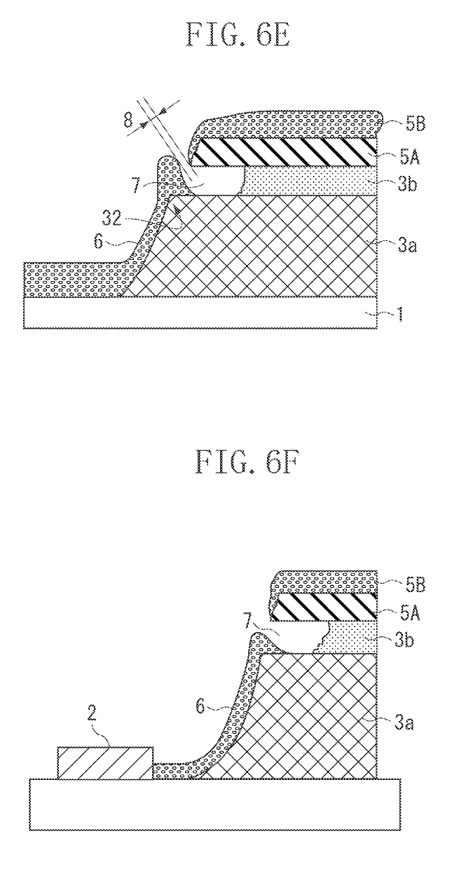

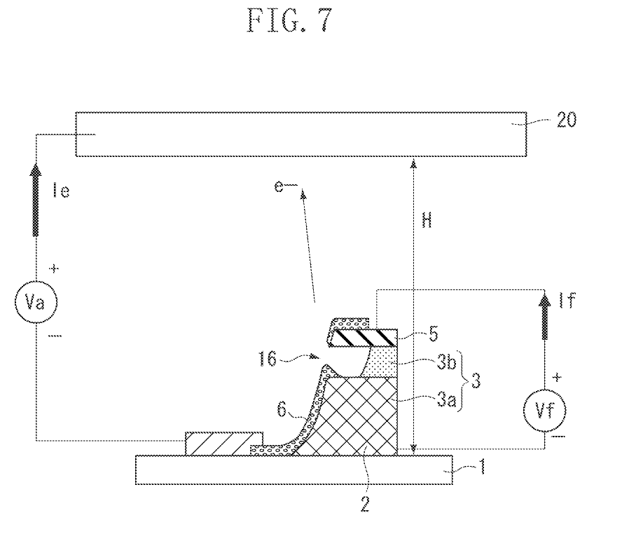

A first exemplary example of the electron emitting device according to the present invention is described hereinafter. A process of manufacturing an electron emitting device according to the present exemplary example is described hereinafter with reference to cross-sectional views illustrated in FIGS. 6A through 6F.

In step 1, first, as illustrated in FIG. 6A, insulating layers 30 and 40 and an electrically conductive layer 50 are stacked on the substrate 1. A high-strain-point low sodium-containing glass (PD200 manufactured by Asahi Glass Co., Ltd.) is used as a material of the substrate 1. The insulating layer 30 is produced by forming a silicon nitride film by a chemical vapor deposition (CVD) method using SiH₄, NH₃, N₂, H₂ gasses such that a thickness of the silicon nitride film is 500 nanometers (nm). The insulating layer 40 is produced by forming a silicon oxide film by the CVD method using SiH₄, and NO₂ gasses such that a thickness of the silicon oxide film is 30 nm. The electrically conductive layer 50 is produced by forming a tantalum nitride film by a sputtering method so that a thickness of the tantalum nitride film is 30 nm.

Next, in step 2, a resist pattern (not illustrated) is formed on the electrically conductive layer 50 by photolithography techniques. Then, the electrically conductive layer 50, the insulating layer 40, and the insulating layer 30 are sequentially processed using a dry etching method (see FIG. 6B). Patterning is performed on the electrically conductive layer 50 and the insulating layer 30 by this etching (i.e., first etching processing) so that a gate electrode 5A and the first insulating layer 3a are formed from the conductive layer 50 and the insulating layer 30, respectively. In this case, materials which produce fluorides are selected as those of the insulating layers 30 and 40, and the electrically conductive layer 50. Accordingly, a CF₄ base gas is used as etching gas. When reactive ion etching (RIE) is performed using this gas, an angle of a side surface of an etched part configured by the insulating layers 30 and 40 and the gate electrode 5A with respect to a surface (or horizontal surface) of the substrate 1 is formed to be about 60°.

Then, in step 3, the resist is peeled off. Then, the insulating layer 40 is etched (see FIG. 6C) using a buffered hydrofluoric acid (BHF (high-purity buffered hydrofluoric acid LAL100 manufactured by STELLA CHEMIFA CORPORATION)) so that the concave portion 7 has a depth of about 70 nm. The above BHF is a mixed solution of ammonium fluoride and hydrofluoric acid. The concave portion 7 is formed in the insulating member 3 configured by the first insulating layer 3a and the second insulating layer 3b by this etching (i.e., second etching).

Next, in step 4, a molybdenum (Mo) film was formed on each of the slope 3f and the top surface 3e of the first insulating layer 3a and the gate electrode 5 by an electron beam heating vapor deposition method such that at least the Mo film formed on the slope 3f of the first insulating layer 3a is 35 nm in thickness (see FIG. 6D). In this step, electrically conductive films 60A and 50B are simultaneously formed. The conductive films 60A and 50B are formed to be contacted with each other. According to the present exemplary example, conditions for electron beam heating vapor deposition are that temperature of the substrate 1 is 100° C., that a deposition speed (or deposition rate) is 2.5 angstroms per second (Å/sec), and that a total pressure is 1×10⁻³ pascal (Pa).

Next, in step 5, wet etching (i.e., third etching) is performed on the conductive films 60A and 50B (see FIG. 6E). An etchant used therefor is 0.238 weight percent (wt %) tetramethylammonium hydroxide (TMAH). The conductive films 60A and 50B are immersed in the etchant for 40 seconds. Then, the conductive films 60A and 50B are washed with running water for 5 minutes. Thus, the conductive films 60A and 50B are alkali-treated. A low film-density part of each of the conductive films 60A and 50B is preferentially etched. Consequently, the cathode 6 (see FIGS. 2B and 2C) including a plurality of protruding portions 16 provided along the corner portion 32, and a gate layer 5B that faced the cathode 6 across the gap 8 and that covered at least the side surface 5a of the gate electrode can be formed. Apparently, the cathode 6 and the gate layer 5B are obtained from the conductive film 60A and the conductive film 50B, respectively, by the third etching.

Next, in step 6, the conductive films 60A and 50B are exposed to the atmosphere. More specifically, the substrate 1 subjected to the treatment in step 4 is taken into the atmosphere and left in the atmosphere at room temperature for 1 hour.

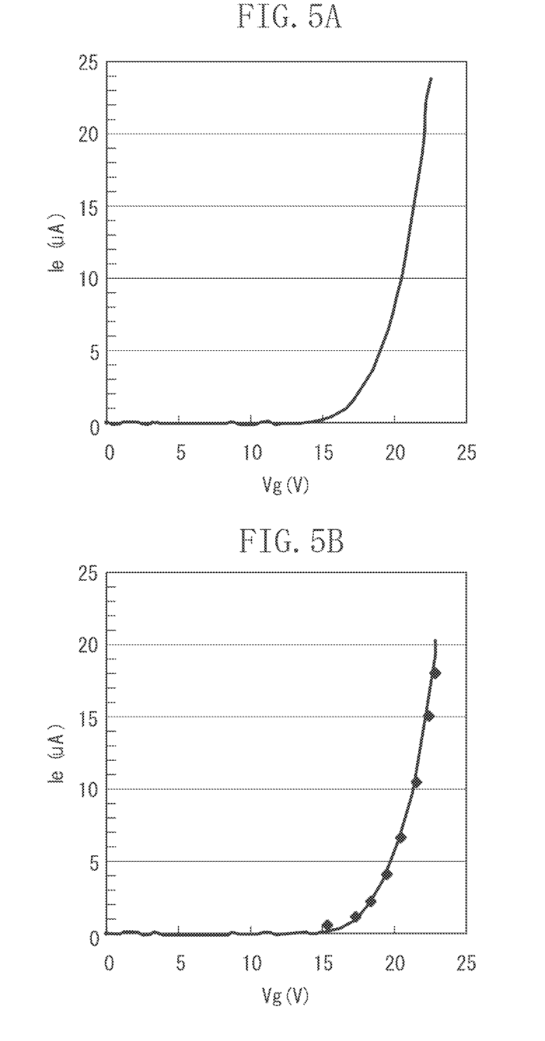

Finally, in step 7, a cathode electrode 2 is formed as illustrated in FIG. 6F. Copper (Cu) is used as a material of the cathode electrode 2. A sputtering method is used as a method for forming the cathode electrode 2. A thickness of the cathode electrode 2 is set at 500 nm. The anode 20 is provided 1.7 mm above the produced electron emitting device, as illustrated in FIG. 7. Then, a voltage at the anode 20 was set at 10 kV, and electron emitting characteristics were measured. When a drive voltage Vf applied between the cathode electrode 2 and the gate electrode 5 was 23 V, an electron emitting current Ie was 24 micro-amperes (μA). The electron emitting characteristics in this case are shown in FIG. 5A.

Then, the TEM-EELS measurement was performed on vicinity (i.e., a portion covering the side surface 5a of the gate electrode 5) of a surface layer of a gate layer 5B. A measurement sample used therefor was a thin section obtained by cutting a portion close to a surface layer of a gate layer 5B of the produced electron emitting device, using a focused ion beam (FIB) processing apparatus, so as to have a cross-section perpendicular to the surface of the substrate 1, as illustrated in FIG. 6F. The sample had a thickness of about 100 nm. Final thin-section formation processing was performed using gallium (Ga) ions having an acceleration voltage of 2 kV.

A transmission electron microscope with an acceleration voltage of 200 kV was used for the TEM-EELS measurement. The measurement was performed by reducing a beam diameter to about 2 nm. A measured energy range extended from 360 eV to 560 eV. A spectrum illustrated in each of the drawings referred to in the following description was obtained by enlarging a part of a measured spectrum. The gate layer 5B is a film containing molybdenum and oxygen. Thus, attention energy ranges are a range extending from 380 eV to 430 eV, in which a spectrum due to molybdenum appeared, and another range extending from 520 eV to 570 eV, in which a spectrum due to oxygen appeared.

FIGS. 1A and 1B illustrate obtained spectra, respectively. According to the present example, the spectrum due to molybdenum has peaks at 300 eV and 416 eV. The spectrum due to oxygen has peaks at 536 eV and 545 eV. The peaks had the following full width at half maximum (FWHM), respectively. The FWHM of a peak (i.e., a first peak) at 399 eV is 4 eV. The FWHM of a peak (i.e., a second peak) at 416 eV is 7 eV. The FWHM of a peak (i.e., a third peak) at 536 eV is 3 eV. The FWHM of a peak (i.e., a fourth peak) at 545 eV is 11 eV.

A large number of electron emitting devices (i.e., samples) were produced by a manufacturing method similar to the method according to the present exemplary embodiments. Then, the TEM-EELS measurement was performed on the gate layer 5B. Thus, it was found that the first peak was present in the range from 397 eV to 401 eV, that the second peak was present in the range from 414 eV to 418 eV, that the third peak was present in the range from 534 eV to 538 eV, and that a fourth peak was present in the range from 540 eV to 547 eV. It was also found that the FWHM of the first peak of each of all of the electron emitting devices ranged from 3 to 5 eV, that the FWHM of the second peak thereof ranged from 6 eV to 8 eV, that the FWHM of the third peak thereof ranged from 2 eV to 4 eV, and that the FWHM of the fourth peak thereof ranged from 9 eV to 14 eV.

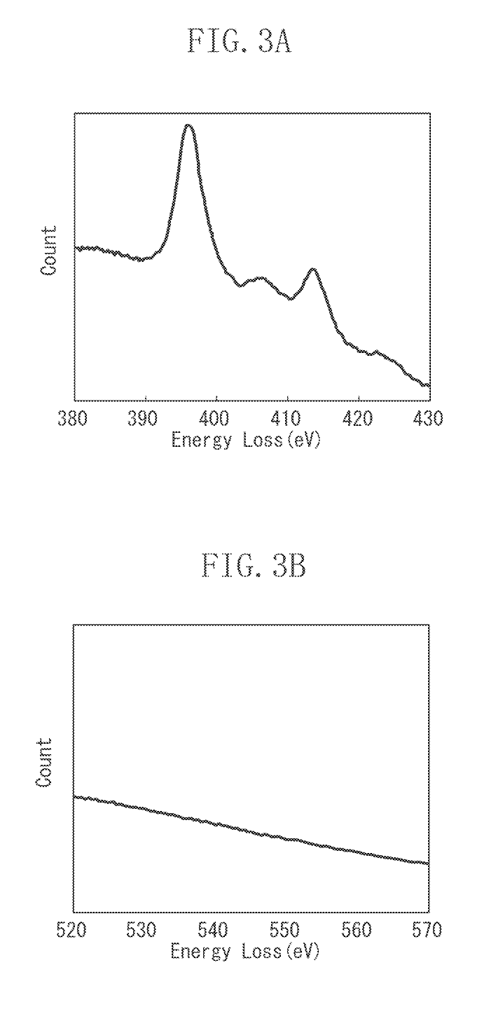

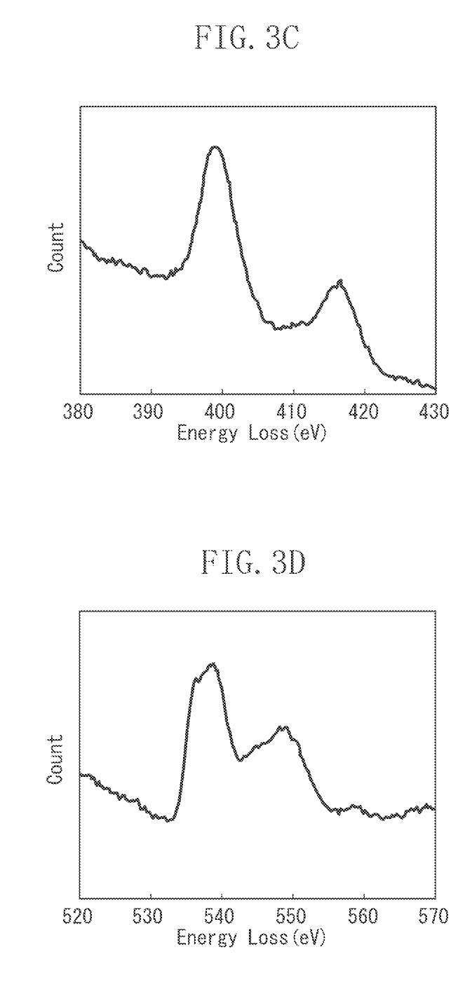

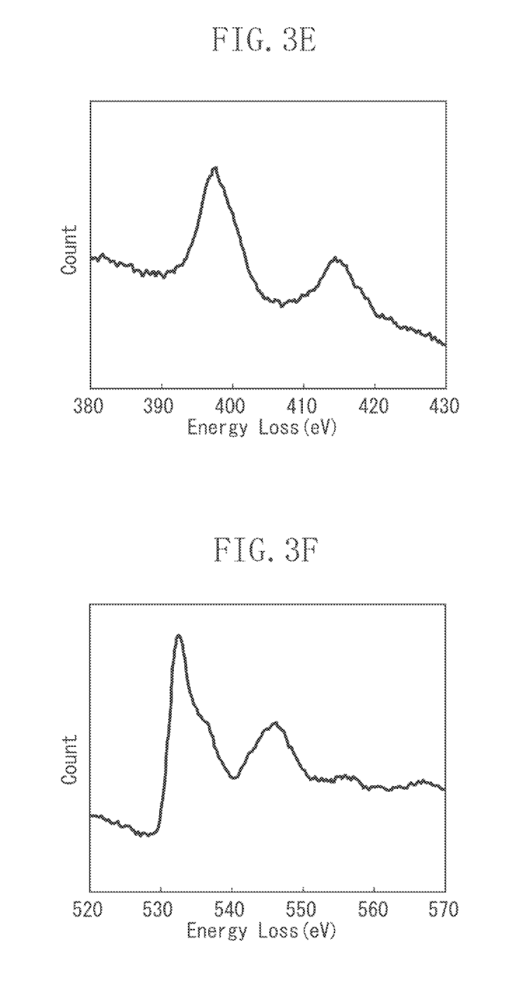

On the other hand, for comparison, TEM-EELS measurement similar to the above measurement was performed on commercially available standard samples (manufactured by KISHIDA CHEMICAL Co., Limited.) respectively made of Mo, MoO₂, and MoO₃. FIGS. 3A and 3B illustrate EEL spectra of the standard sample made of Mo, respectively. FIGS. 3C and 3D illustrate EEL spectra of the standard sample made of MoO₂, respectively. FIGS. 3E and 3F illustrate EEL spectra of the standard sample made of MoO₃, respectively.

The spectra illustrated in FIGS. 1A and 1B are compared with those illustrated in FIGS. 3A and 3B, respectively. The spectrum illustrated in FIG. 3A has a first peak measured at 396 eV. The first peak of the spectrum illustrated in FIG. 1A differs in position from the first peak of the spectrum illustrated in FIG. 3A. The measured spectrum illustrated in FIG. 3B has no peaks respectively corresponding to the third peak and the four peaks illustrated in FIG. 1B.

Next, the spectra illustrated in FIGS. 1A and 1B are compared with those illustrated in FIGS. 3C and 3D, respectively. A first peak of the spectrum illustrated in FIG. 3C was observed at 399 eV, similarly to that of the spectrum illustrated in FIG. 1A. On the other hand, a third peak of the spectrum illustrated in FIG. 3D is observed at 538 eV, and a fourth peak thereof was observed at 548 eV. The third peak and the fourth peak of the spectrum illustrated in FIG. 3D differ in position from those of the spectrum illustrated in FIG. 1B, respectively.

Next, the spectra illustrated in FIGS. 3E and 3F are compared with those illustrated in FIGS. 1A and 1B, respectively. A first peak of the spectrum illustrated in FIG. 3E is observed at 398 eV and slightly differs in position from the first peak of the spectrum illustrated in FIG. 1A. However, a third peak and a fourth peak of the spectrum illustrated in FIG. 3F are observed at 533 eV and 546 eV, respectively. Thus, the third peak of the spectrum illustrated in FIG. 3F differs largely from the third peak of the spectrum illustrated in FIG. 1B in position.

Thus, it is found that the surface layer portion (i.e., the gate layer 5B) of the gate 5 onto which electrons emitted from the cathode 6 are irradiated has a special composition differing from that of each of pure Mo, MoO₂, and MoO₃.

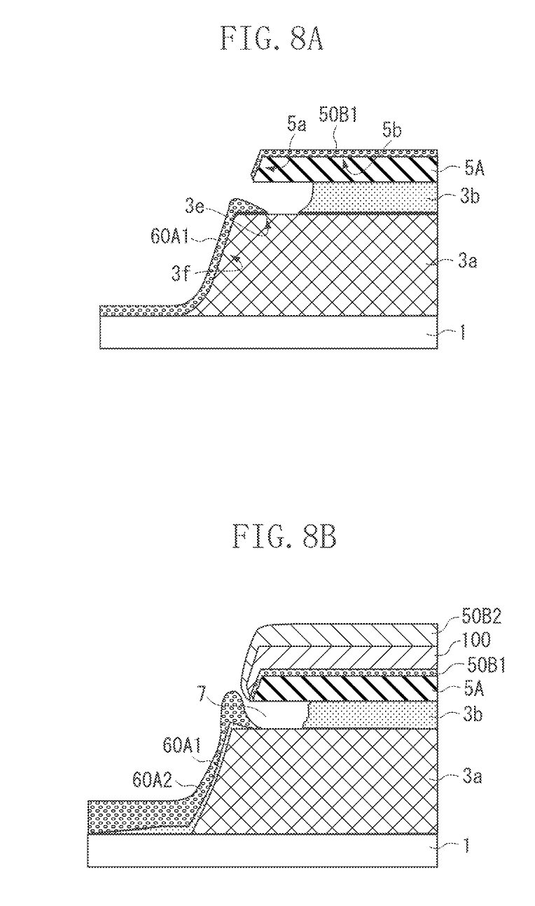

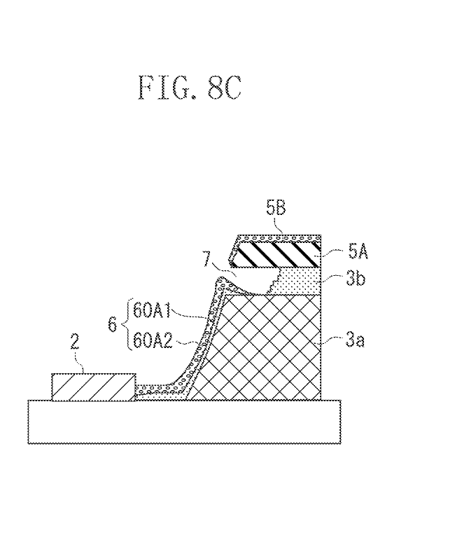

A first comparative example is described hereinafter. According to the first comparative example, a method for forming the gate layer according to the first example was changed. More specifically, step 1 through step 3 of the first comparative example were performed, similarly to step 1 through step 3 of the first exemplary example. Hereinafter, step 4 and later steps of the first comparative example are described with reference to FIGS. 8A through 8C. FIGS. 8A through 8C respectively correspond to FIGS. 6D through 6F with reference to which the first exemplary example has been described.

Next, in step 4, a Mo film is formed on the slope 3f and the top surface 3e of the first insulating layer 3a and the gate electrode 5A by a directional sputtering method (see FIG. 8A). In this step, electrically conductive films 60A1 and 50B1 are formed. The conductive film 50B1 covers a side surface 5a and a top surface 5b of the gate electrode 5.

In the above film formation step, an angle of a surface of the substrate 1 with respect to a sputter target was set to correspond to a horizontal direction. According to the first comparative example, a shield was provided between the substrate 1 and the target such that each sputtering particle was incident upon a surface of the substrate 1 at a limited angle (more specifically, 80° with respect to the surface of the substrate 1). In addition, argon plasma was generated at electric-power of 3 kilo-watts (kW), and a degree of vacuum of 0.1 Pa. The substrate 1 was arranged such that a distance between the substrate 1 and the Mo-target was 60 mm (i.e., equal to or less than a mean free path at a pressure of 0.1 Pa). Then, the Mo film was formed at a deposition rate of 10 nm per minute (nm/min) such that a thickness of the Mo film on the slope of the insulating layer 3 was 15 nm.

In step 5, a resist mask 100 is formed only on an electrically conductive film 50B1 to cover an electrically conductive film 50B1. Then, similar to the first exemplary example, a Mo film was formed on each of the slope 3f and the top surface 3e of the first insulating layer 3a and the gate electrode 5A by the electron beam heating vapor deposition method. Various conditions for the electron beam heating vapor deposition method are the same as those described in the description of step 4 according to the first exemplary example. In step 5, the electrically conductive film 60A2 covering an electrically conductive film 60A1, and an electrically conductive film 50B2 covering the mask 100 are formed. The conductive films 60A1 and 60A2 located on the slope 3f of the first insulating layer 3 were formed so that, similar to the conductive films according to the first exemplary example, a total thickness of the conductive films 60A1 and 60A2 was 35 nm.

Next, in step 6, wet etching (i.e., third etching) is performed on the conductive films 60A2 and 50B2, similarly to step 5 according to the first exemplary example. Various conditions for the wet etching are set to be similar to those set in step 5 in the first exemplary example.

Finally, in step 8, the resist mask 100 was peeled off. Thus, the gate layer 5B (or the conductive film 50B1) covering the top surface 5b and the side surface 5a of the gate electrode 5A was exposed. Then, the cathode electrode 2 was formed, similarly to that according to the first exemplary example (see FIG. 8C).

It was confirmed from a TEM image that the electron emitting device formed through the above steps and the electron emitting device according to the first exemplary example were equivalent to each other in the shape of the protruding portions 16 of the cathode 6 and in the width of the gap 8 serving as the shortest distance between the gate layer 5B and the cathode 6.

In a case where the electron emitting characteristics of the electron emitting device were measured similarly to those of the electron emitting device according to the first exemplary example, when the drive voltage applied between the cathode electrode 2 and the gate electrode 5A was 23 V, the electron emitting current Ie was 21 μA. The electron emitting characteristics of the device in this case are illustrated in FIG. 5B.

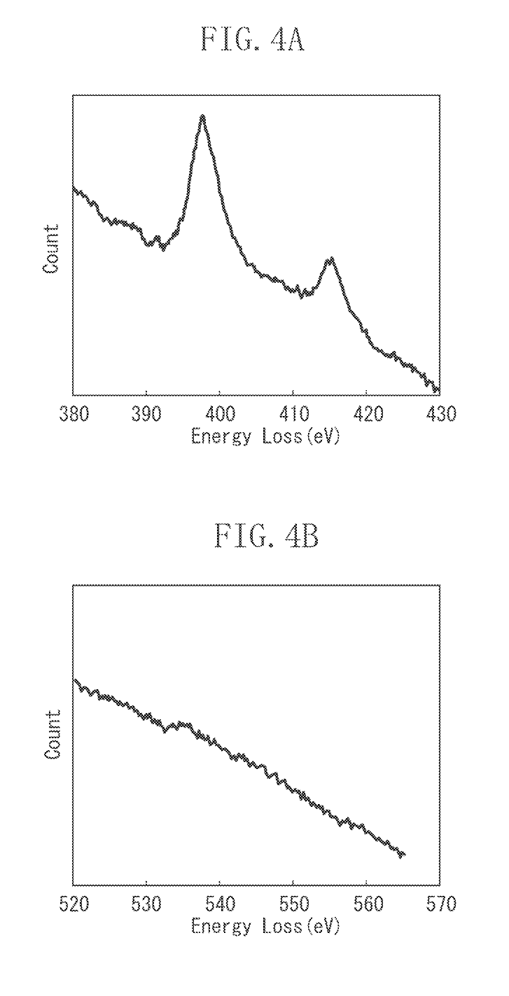

FIGS. 4A and 4B illustrate results of measuring EEL spectra, similarly to the first exemplary example, at a portion covering the side surface 5a of the gate electrode 5A of the gate layer 5B of the present comparative example. The spectrum according to the present comparative example has peaks due to molybdenum at 398 eV and 415 eV. However, the spectrum according to the present comparative example has no peaks due to oxygen in a range from 520 eV to 570 eV.

In a case where an electron emitting device according to a modification was produced, similarly to the first exemplary example except that the step 6 of exposing the conductive films to the atmosphere according to the first exemplary example was not performed, an EEL spectrum substantially similar to that of the electron emitting device according to the first comparative example was measured. In other words, no significant peaks due to oxygen were observed in the range of energy from 520 eV to 570 eV. The electron emitting device according to the modification was lower than the electron emitting device according to the first exemplary example in the electron emitting current Ie and the electron emitting efficiency η (i.e., a ratio of the electron emitting current (Ie) to electric current (If) (=Ie/If)) flowing between the cathode and the gate.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-232626 filed Oct. 15, 2010, which is hereby incorporated by reference herein in its entirety.

What is claimed is:

1. An electron emitting device comprising:
a cathode; and
a gate onto which electrons field-emitted from the cathode are irradiated,
wherein the gate includes at least a layer containing molybdenum and oxygen provided at a portion onto which the electrons field-emitted from the cathode are irradiated, and
wherein the layer has peaks in a range of 397 eV through 401 eV, a range of 414 eV through 418 eV, a range of 534 eV through 538 eV, and a range of 540 eV through 547 eV, respectively, in a spectrum measured by electron energy loss spectroscopy using a transmission electron microscope.

2. The electron emitting device according to claim 1,
wherein the gate includes a gate electrode, and
wherein the layer covers the gate electrode.

3. An electron emitting apparatus comprising:
an electron emitting device according to claim 1; and
an anode.

4. An image display apparatus comprising:
an electron emitting apparatus according to claim 3 further including a phosphor.

5. The electron emitting apparatus according to claim 1, wherein the gate in the electron emitting device further includes agate electrode, and wherein the layer covers the gate electrode.

6. The electron emitting apparatus according to claim 5, further comprises an anode.

7. The image display apparatus according to claim 4, wherein the electron emitting device further includes a gate electrode, and wherein the layer covers the gate electrode.
